(19) United States
(12) Patent Application Publication
(10) Pub. No.: US 2019/0122117 A1
(43) Pub. Date: Apr. 25, 2019

(54) LEARNING DEVICE, NON-TRANSITORY COMPUTER READABLE STORAGE MEDIUM, AND LEARNING METHOD

(71) Applicant: YAHOO JAPAN CORPORATION, Tokyo (JP)

(72) Inventors: Tasuku MIYAZAKI, Tokyo (JP); Hayato KOBAYASHI, Tokyo (JP); Kohei SUGAWARA, Tokyo (JP); Masaki NOGUCHI, Tokyo (JP)

(73) Assignee: YAHOO JAPAN CORPORATION, Tokyo (JP)

(21) Appl. No.: 16/117,137

(22) Filed: Aug. 30, 2018

(30) Foreign Application Priority Data
Oct. 19, 2017 (JP) 2017-202996

(51) Int. Cl. G06N 3/08; G06N 3/04

(52) U.S. Cl. CPC G06N 3/084; G06N 3/0445

(57) ABSTRACT

According to one aspect of an embodiment a learning device includes a learning unit that learns an encoder that includes an input layer to which input information is input, a plurality of intermediate layers that extract features of the input information from output of the input layer in a stepwise manner, and an output layer that outputs the features of the input information extracted by the plurality of intermediate layers. The learning unit learns an applier that applies, to output of the encoder, an attention matrix including a plurality of column components that are based on a plurality of attributes extracted by the plurality of intermediate layers. The learning unit learns a decoder that generates output information corresponding to the input information from the output of the encoder to which the attention matrix has been applied by the applier.

### CROSS-REFERENCE TO RELATED APPLICATIONS

The present application claims priority to and incorporates by reference the entire contents of Japanese Patent Application No. 2017-202996 filed in Japan on Oct. 19, 2017.

### BACKGROUND OF THE INVENTION

### 1. Field of the Invention

The present invention relates to a learning device, a program parameter, a non-transitory computer readable storage medium and a learning method.

### 2. Description of the Related Art

In recent years, a technology for learning a feature of input information, such as language recognition or image recognition, by using deep neural network (DNN) including neurons that are connected in a multistage manner has been known. For example, a model to which the technology as described above is applied extracts a feature by compressing the dimensional quantity of input information, and generates output information corresponding to the feature of the input information by gradually extending the dimensional quantity of the extracted feature.
Patent Literature 1: Japanese Laid-open Patent Publication No. 2006-127077;
Non Patent Literature 1: “Learning Phrase Representations using RNN Encoder-Decoder for Statistical Machine Translation”, Kyunghyun Cho, Bart van Merrienboer, Caglar Gulcehre, Dzmitry Bandanau, Fethi Bougares, Holger Schwenk, Yoshua Bengio, arXiv:1406.1078v3 [cs.CL] 3 Sep. 2014; and
Non Patent Literature 2: “Neural Responding Machine for Short-Text Conversation” Lifeng Shang, Zhengdong Lu, Hang Li<https://arxiv.org/pdf/1503.02364.pdf>.

However, in the conventional technology as described above, it is not always possible to output appropriate output information in accordance with the feature of the input information.

For example, when a feature is extracted by compressing a dimensional quantity of input information, peripheral information on the feature may be lost. If the peripheral information on the feature is lost, it is difficult to generate output information in which the peripheral information on the feature of the input information is taken into account. Therefore, in the conventional technology as described above, for example, when speech made by a user is handled as input information and a response to the speech is handled as output information, the response is output using only the feature included in the speech. Consequently, in some cases, it may be difficult to generate, as the output information, text with natural contents, such as a response that reflects an intent that is not directly expressed in the speech.

### SUMMARY OF THE INVENTION

It is an object of the present invention to at least partially solve the problems in the conventional technology.

According to one aspect of an embodiment a learning device includes a learning unit that learns an encoder that includes an input layer to which input information is input, a plurality of intermediate layers that extract features of the input information from output of the input layer in a stepwise manner, and an output layer that outputs the features of the input information extracted by the plurality of intermediate layers. The learning unit learns an applier that applies, to output of the encoder, an attention matrix including a plurality of column components that are based on a plurality of attributes extracted by the plurality of intermediate layers. The learning unit learns a decoder that generates output information corresponding to the input information from the output of the encoder to which the attention matrix has been applied by the applier.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a learning process performed by a learning device according to an embodiment;

FIG. 2 is a diagram illustrating examples of a chronological structure of intermediate layers of an encoder according to the embodiment;

FIG. 3 is a diagram illustrating a configuration example of the learning device according to the embodiment;

FIG. 4 is a diagram illustrating an example of information registered in a correct answer data database according to the embodiment;

FIG. 5 is a flowchart illustrating the flow of a process according to the embodiment; and

FIG. 6 is a diagram illustrating an example of a hardware configuration.

### DETAILED DESCRIPTION OF THE PREFERRED EMBODIMENTS

Modes (hereinafter, referred to as “embodiments”) for carrying out a learning device, a non-transitory computer readable storage medium and a learning method according to the present application will be described in detail below with reference to the drawings. The learning device, the non-transitory computer readable storage medium and the learning method according to the present application are not limited by the embodiments below. In the following embodiments, the same components are denoted by the same reference signs, and the same explanation will be omitted.

### Embodiment

1-1. Example of Learning Device

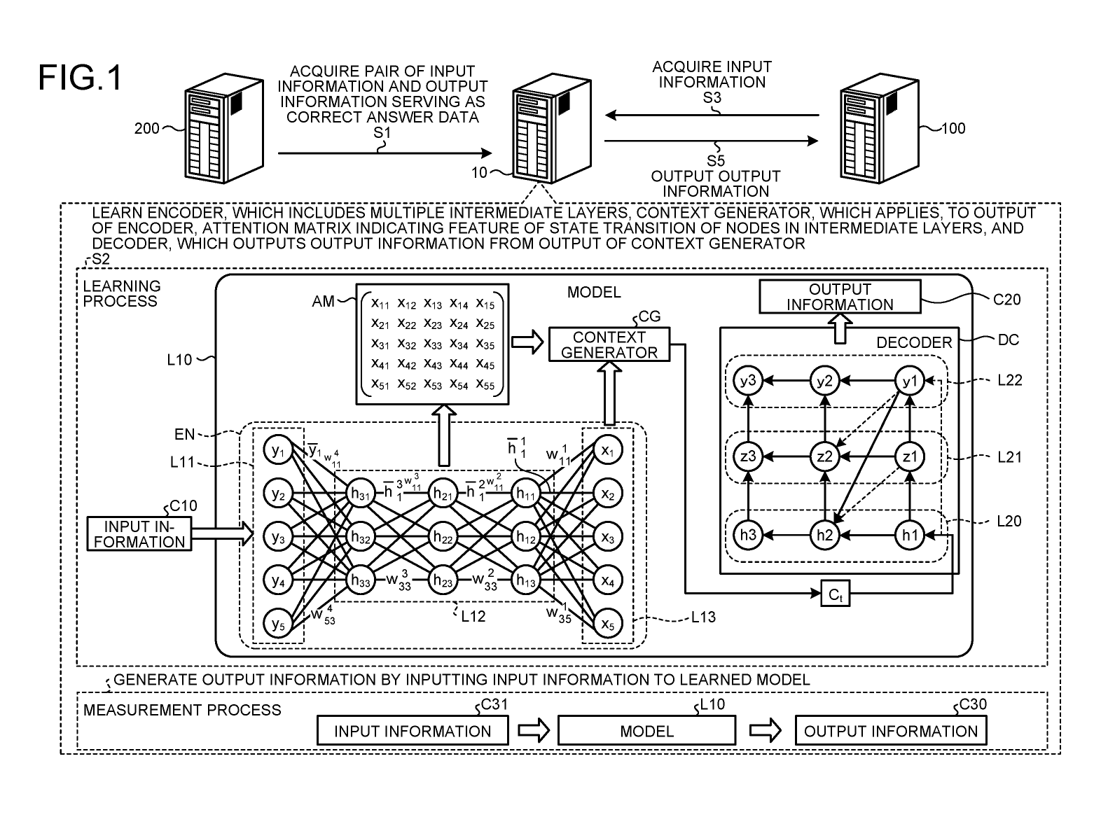

First, an example of a learning process performed by a learning device will be described with reference to FIG. 1. FIG. 1 is a diagram illustrating an example of the learning process performed by the learning device according to the embodiment. In FIG. 1, a learning device 10 is an information processing apparatus that performs the learning process as described below, and is realized by, for example, a server device, a cloud system, or the like.

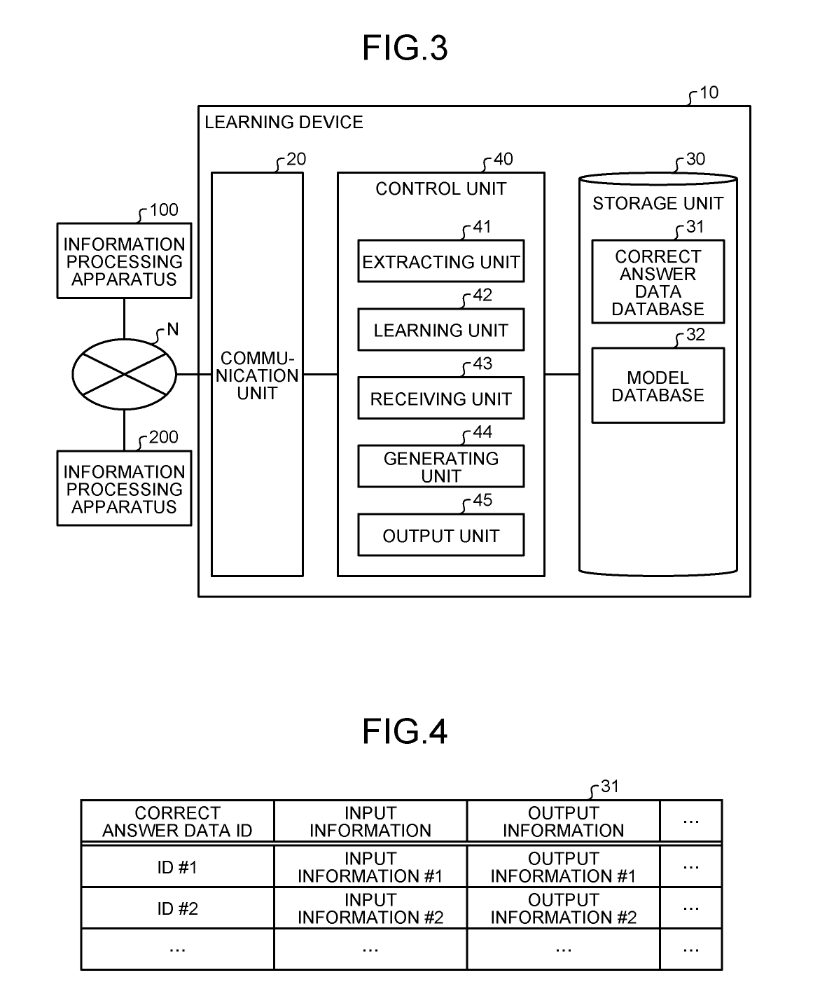

More specifically, the learning device 10 is able to communicate with information processing apparatuses 100 and 200 used by arbitrary users, via a predetermined network N (for example, see FIG. 3), such as the Internet. For example, the learning device 10 transmits and receives various kinds of data to and from the information processing apparatuses 100 and 200.

The information processing apparatuses 100 and 200 are realized by information processing apparatuses, e.g., smart devices such as smartphones or tablets, desktop personal computers (PCs), notebook PCs, or server devices.

1-2. Overview of Model Learned by Information Processing Apparatus

The learning device 10 generates a model L10, which outputs information (hereinafter, described as “output information”) corresponding to information that is input (hereinafter, described as “input information”) in response to the input information. The model L10 is, for example, w2v (word2vec) or s2v (sentence2vec), that converts a word or a sentence into a vector (multidimensional quantity) and outputs a response corresponding to the input sentence using the converted vector. As another example, the model L10 outputs a still image or a moving image corresponding to an input still image or an input moving image. As still another example, when a user attribute is input as the input information, the model L10 outputs information indicating contents or a type of advertisement to be provided to the user.

In addition, for example, when an arbitrary content, such as news or various kinds of posted information posted by a user on a social networking service (SNS), is input as the input information, the model L10 outputs a corresponding arbitrary content as the output information. In other words, the model L10 is able to handle any kind of information as the input information and the output information as long as the model L10 outputs corresponding output information upon input of input information.

When a DNN is adopted as the model L10, it may be possible to adopt a structure for extracting a feature of input information and generating output information based on the extracted feature. For example, as a structure of the model L10, it may be possible to adopt a structure including an encoder EN that extracts a feature of input information and a decoder DC that generates output information based on output of the encoder EN. The encoder EN and the decoder DC of the model L10 as described above are configured with any kind of neural network, such as an autoencoder, a recurrent neural network (RNN), or a long short-term memory (LSTM).

In this example, to extract a feature of input information, for example, the encoder EN includes a plurality of intermediate layers for extracting, from the input information, features included in the input information. For example, when the encoder EN is realized by an autoencoder, the encoder EN includes a plurality of intermediate layers that gradually reduce the number of dimensions of the input information. The intermediate layers as described above extract features included in the input information by gradually reducing the number of dimensions of the input information.

In this example, the decoder DC of the model L10 generates output information based on the features included in the input information. However, because the features output by the encoder EN are extracted by gradually reducing the number of dimensions of the input information, information useful for generating the output information may have been lost. In other words, the encoder EN sends only the features included in the input information to the decoder DC, so that the accuracy of the output information output by the decoder DC may be reduced.

To cope with this situation, the learning device 10 performs a learning process as described below. For example, the learning device 10 learns: an encoder that includes an input layer to which the input information is input, a plurality of intermediate layers that extract features of the input information from output of the input layer in a stepwise manner, and an output layer that outputs the features of the input information extracted by the plurality of intermediate layers; a context generator that applies, to output of the encoder, an attention matrix including a plurality of column components that are based on a plurality of attributes extracted by the plurality of intermediate layers; and a decoder that generates output information corresponding to the input information from the output of the encoder to which the attention matrix has been applied by the context generator.

For example, the learning device 10 learns a context generator that applies an attention matrix including a plurality of column components that are based on states of nodes included in the intermediate layers at the time of inputting information to the input layer. Further, for example, the learning device 10 learns a context generator that applies an attention matrix in which values corresponding to states of nodes included in the same intermediate layer are arranged in the same column.

In other words, the information processing apparatus 100 applies, to output of the encoder, an attention matrix that is based on a plurality of features that the encoder extracts from the input information, and sends the output of the encoder as a matrix rather than a value to the decoder. Then, the learning device 10 learns a decoder so as to generate output information from the output of the encoder to which the attention matrix is applied.

The attention matrix applied as described above indicates features of the states of the nodes in the intermediate layers at the time of inputting the input information to the encoder. In other words, the attention matrix indicates not only features of the input information but also peripheral information on the features. By applying the attention matrix as described above to the output of the encoder, that is, information indicating the features that the encoder has extracted from the input information, the information processing apparatus 100 is able to apply information that is lost in the intermediate layers (in other words, features of the peripheral information on the features) to the output of the encoder. The information processing apparatus 100 causes the decoder to generate output information from the matrix that indicates the features extracted by the encoder and the features indicated by the attention matrix. As a result, the information processing apparatus 100 is able to improve the accuracy of the output information generated by the model.

1-3. Encoder

The learning device 10 may adopt, as the encoder, a neural network with an arbitrary structure, such as an RNN, an LSTM, a convolutional neural network (CNN), or a deep predictive coding network (DPCN). Further, the learning device 10 may adopt a neural network with the structure of a DPCN to each of the layers.

For example, when adopting a neural network with the structure of an RNN as the encoder, the learning device 10 learns an encoder that includes a plurality of intermediate layers including nodes that generate newly output information on the basis of newly input information and previously output information. In this manner, the learning device 10 may learn an encoder of any type as long as the learning device 10 learns an encoder that includes an intermediate layer having a plurality of layers.

1-4. Generation of Attention Matrix

The learning device 10 may set column components of the attention matrix using any method as long as the learning device 10 sets the column components of the attention matrix based on states of a plurality of nodes in the intermediate layers included in the encoder, that is, in the intermediate layers that extract features of input information. For example, when the encoder includes a first intermediate layer, a second intermediate layer, and a third intermediate layer from the output layer side, the learning device 10 associates nodes included in the first intermediate layer with a first row of the attention matrix, associates nodes included in the second intermediate layer with a second row of the attention matrix, and associates nodes included in the third intermediate layer with a third row of the attention matrix. Then, the learning device 10 sets each of values of the attention matrix based on a value output from each of the nodes or a condition of each of the nodes. In other words, the learning device 10 learns a context generator that generates an attention matrix including a plurality of column components based on each of the nodes included in the plurality of intermediate layers.

In this example, the learning device 10 may set a window with a predetermined size in the plurality of intermediate layers, and set a submatrix constituting the attention matrix based on states or output of nodes included in the window among the nodes included in the intermediate layers. Further, the learning device 10 may generate a plurality of submatrices by appropriately moving the window as described above, and set an attention matrix from the plurality of generated submatrices. In other words, the learning device 10 may learn a context generator that applies an attention matrix that is based on a plurality of submatrices corresponding to states of some of the nodes included in the plurality of intermediate layers.

Further, when the intermediate layers of the encoder have a structure, such as an RNN, for outputting new information based on previously output information and newly input information, the learning device 10 may learn a context generator that applies an attention matrix having values of elements corresponding to a chronological structure that is for providing information from the intermediate layers to other layers. For example, it is assumed that an encoder includes the first intermediate layer, the second intermediate layer, and the third intermediate layer from the output layer side. Nodes that belong to each of the intermediate layers of the encoder of this example output new information based on previously output information and newly input information. However, there are chronological variations in terms of a timing at which the new information is sent to a next layer or a type of information to be a basis for generating the new information.

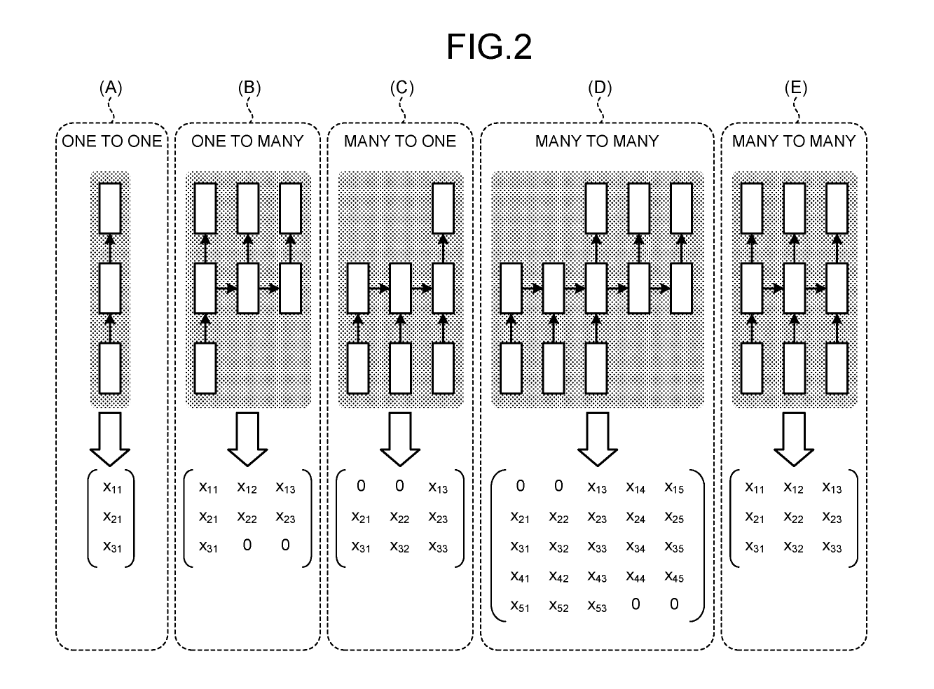

For example, FIG. 2 is a diagram illustrating examples of a chronological structure of intermediate layers of the encoder according to the embodiment. In FIG. 2, examples of the chronological structure for providing information from three intermediate layers included in the encoder are illustrated. In addition, FIG. 2 only illustrates an example of the chronological structure for providing information from the intermediate layers, and the embodiment is not limited to this example.

For example, when the learning device 10 applies an attention matrix in accordance with a condition of each of intermediate layers in an encoder that includes intermediate layers of a first intermediate layer to an m-th intermediate layer during a period from a timing t to a timing t+n, the learning device 10 learns a context generator that applies an attention matrix of m rows and n−1 columns. In other words, the learning device 10 learns a context generator that applies an attention matrix, which includes elements corresponding to nodes included in the plurality of intermediate layers and which has column components corresponding to states of the respective nodes at the time of inputting predetermined information and row components corresponding to chronological states of the respective nodes.

For example, as illustrated in (A) in FIG. 2, an encoder having a one-to-one structure will be described: at the timing t at which certain information is input, information is sent from a node in the first intermediate layer to a node in the second intermediate layer and then sent from the node in the second intermediate layer to a node in the third intermediate layer. In this case, the learning device 10 learns a context generator that applies an attention matrix including an element x₁₁ that is based on the node in the third intermediate layer, an element x₂₁ that is based on the node in the second intermediate layer, and an element x₃₁ that is based on the node in the first intermediate layer. In other words, the learning device 10 sets an attention matrix in which the elements corresponding to the respective nodes are arranged in the column direction.

Further, for example, as illustrated in (B) in FIG. 2, an encoder having a one-to-many structure will be described: at the timing t, information is sent from the node in the first intermediate layer to the node in the second intermediate layer and then sent from the node in the second intermediate layer to the node in the third intermediate layer; at the timing t+1, a new value that is based on a value that the node in the second intermediate layer has output at the timing t is sent to the third intermediate layer; and at the timing t+2, a value that is based on the value that the node in the second intermediate layer has output at the timing t+1 is sent to the third intermediate layer. In this case, the learning device 10 learns a context generator that sets an attention matrix, in which elements based on the states of the respective nodes at the timing t are arranged in the first column, elements based on the states of the respective nodes at the timing t+1 are arranged in the second column, and elements based on the states of the respective nodes at the timing t+3 are arranged in the third column.

More specifically, the learning device 10 learns a context generator that applies an attention matrix including the element x₁₁ that is based on the node in the third intermediate layer at the timing t, the element x₂₁ that is based on the node in the second intermediate layer at the timing t, and the element x₃₁ that is based on the node in the first intermediate layer at the timing t. Further, the learning device 10 learns a context generator that applies an attention matrix including an element x₁₂ that is based on the node in the third intermediate layer at the timing t+1, an element x₂₂ that is based on the node in the second intermediate layer at the timing t+1, and an element x₃₂ that is based on the node in the first intermediate layer at the timing t+1. Furthermore, the learning device 10 learns a context generator that applies an attention matrix including an element x₁₃ that is based on the node in the third intermediate layer at the timing t+2, an element x₂₃ that is based on the node in the second intermediate layer at the timing t+2, and an element x₃₃ that is based on the node in the first intermediate layer at the timing t+2.

In this example, at the timing t+1 and the timing t+2, information is not input to the node in the first intermediate layer from the input layer, and information is not output from the node in the first intermediate layer. Therefore, the learning device 10 learns a context generator that applies an attention matrix, in which a row component corresponding to a node to which information is not provided from other nodes is set to zero in a certain chronological sequence. More specifically, the learning device 10 adopts “0” as values of the element x₃₂ and the element x₃₃.

Similarly, as illustrated in (C) in FIG. 2, an encoder having a many-to-one structure will be described: at the timing t, information is sent from the node in the first intermediate layer to the node in the second intermediate layer; at the timing t+1, information is sent from the node in the first intermediate layer to the node in the second intermediate layer and information that the node in the second intermediate layer has generated at the timing t is fed back to the node in the second intermediate layer; and at the timing t+2, information is sent from the node in the first intermediate layer to the node in the second intermediate layer and information that is based on information that the node in the second intermediate layer has generated at the timing t+1 and based on the information sent from the node in the first intermediate layer is transmitted to the node in the third intermediate layer. In this case, in the learning device 10, no value is input to the node in the third intermediate layer at the timing t and the timing t+1. Therefore, the learning device 10 learns a context generator that applies an attention matrix, in which values of the element x₁₁ and the element x₁₂ are set to “0” and a value of each of the nodes is set to a value that is based on information output by each of the nodes.

In this example, the context generator may set a plurality of elements included in the attention matrix on the basis of the state of a node included in a single intermediate layer. For example, when the context generator applies an attention matrix in accordance with a condition of each of the intermediate layers in an encoder that includes intermediate layers of the first intermediate layers to the third intermediate layers during a period from the timing t to the timing t+4, it may be possible to apply an attention matrix of three rows and five columns.

For example, as illustrated in (D) in FIG. 2, an encoder having a many-to-many structure will be described, in which information is sent from the node in the first intermediate layer to the node in the second intermediate layer during a period from the timing t to the timing t+2, output of the node in the second intermediate layer is fed back to the node in the second intermediate layer during a period from the timing t to the timing t+4, and output of the node in the second intermediate layer is sent to the node in the third intermediate layer during a period from the timing t+2 to the timing t+4. In this case, the context generator may set elements x₅₁ to x₅₅ in the fifth row of the attention matrix based on output from the first intermediate layer at the timings t to t+4, set elements x₂₁ to x₂₅, x₃₁ to x₃₅, and x₄₁ to x₄₅ in the second row to the fourth row of the attention matrix based on output from the second intermediate layer at the timings t to t+4, and set elements x₁₁ to x₁₅ in the first row of the attention matrix based on output from the third intermediate layer at the timings t to t+4.

For example, the context generator may set the elements x₄₁ to x₄₅ in the fourth row of the attention matrix based on input to the second intermediate layer, set the elements x₃₁ to x₃₅ in the third row of the attention matrix based on the state of the second intermediate layer, and set the elements x₂₁ to x₂₅ in the second row of the attention matrix based on output of the second intermediate layer. Further, for example, the context generator may set the elements x₄₁ to x₄₅ in the fourth row of the attention matrix based on a coefficient of connection from the first intermediate layer to the second intermediate layer, set the elements x₃₁ to x₃₅ in the third row of the attention matrix based on output of the second intermediate layer, and set the elements x₂₁ to x₂₅ in the second row of the attention matrix based on a coefficient of connection from the second intermediate layer to the third intermediate layer.

Furthermore, for example, as illustrated in (E) in FIG. 2, an encoder having a many-to-many structure will be described, in which information is sent from the node in the first intermediate layer to the node in the second intermediate layer during a period from the timing t to the timing t+2, output of the node in the second intermediate layer is fed back to the node in the second intermediate layer during the period from the timing t to the timing t+2, and output of the node in the second intermediate layer is sent to the node in the third intermediate layer during the period from the timing t to the timing t+2. In this case, the context generator may set the elements x₃₁ to x₃₃ in the third row of the attention matrix based on output of the first intermediate layer at the timings t to t+2, set the elements x₂₁ to x₂₃ in the second row of the attention matrix based on output of the second intermediate layer at the timings t to t+2, and set the elements x₁₁ to x₁₃ in the first row of the attention matrix based on output of the third intermediate layer at the timings t to t+2.

Moreover, the learning device 10 may apply an attention matrix to output of the encoder using an arbitrary method. For example, the learning device 10 may adopt, as a feature matrix, a matrix in which an attention matrix is simply integrated with output of the encoder. Furthermore, the learning device 10 may apply a matrix that is based on the attention matrix to output of the encoder.

For example, an eigenvalue or an eigenvector of the attention matrix indicates a feature of the attention matrix, that is, a feature of a word group. Therefore, the learning device 10 may apply the eigenvalue or the eigenvector of the attention matrix to output of the encoder. For example, the learning device 10 may input a product of the eigenvalue of the attention matrix and output of the encoder to the decoder, or input a product of the eigenvector of the the attention matrix and output of the encoder to the decoder. Furthermore, the learning device 10 may apply a singular value of the attention matrix to output of the encoder, and input the singular value to the decoder.

1-5. Configuration of Decoder

The learning device 10 may learn a decoder having an arbitrary structure as long as the decoder generates output information from output of the encoder to which the attention matrix is applied. For example, the learning device 10 may learn a decoder that is realized by a neural network, such as a CNN, an RNN, an LSTM, or a DPCN.

For example, the decoder includes a state layer, a reconstruction layer, and a word reconstruction layer from the input layer side to the output layer side. The decoder as described above changes the state of one or a plurality of nodes included in the state layer to a state h1 upon receiving output of the encoder to which the attention matrix is applied. Then, the decoder reconstructs, in the reconstruction layer, an attribute z1 of firstly-input input information from the state h1 of the node in the state layer, and, in the word reconstruction layer, reconstructs first input information y1 from the state h1 and the attribute z1 and changes the state of the node in the state layer to a state h2 from the input information y1 and the state h1. The decoder may be provided with a function of the LSTM or the DPCN in the state layer, and change the state of the node in the state layer to the state h2 by taking into account the output attribute z1. Subsequently, the decoder reconstructs, in the reconstruction layer, an attribute z2 of secondly-input input information from the previously-reconstructed attribute z1 and the current state h2 of the node in the state layer, and reconstructs secondly-input input information y2 from the attribute z2 and the previously-reconstructed input information y1.

In the decoder as described above, when the decoder is learned such that input information that has been input to the encoder is reconstructed in a state in which the reconstruction layer is provided with a function of a recurrent neural network, such as a DPCN, the reconstruction layer learns a feature of sequence of the input information. As a result, the decoder predicts an attribute of input information to be reconstructed next, on the basis of the attribute of the input information that has previously been reconstructed. In other words, the decoder predicts a sequence of appearance of the input information. When a plurality of pieces of input information are sequentially input at the time of measurement, the decoder as described above generates output information by taking into account the importance of the pieces of input information depending on the sequence.

1-6. Measurement Process

The learning device 10 performs a measurement process of generating output information from input information that is received from the information processing apparatus 100, by using a model for which learning has been performed through the learning process as described above. For example, upon receiving pieces of input information from the information processing apparatus 100, the learning device 10 sequentially inputs the pieces of received input information to the encoder of the model, and sequentially outputs pieces of output information generated by the decoder to the information processing apparatus 100.

1-7. Example of Process Performed by Learning Device 10

Next, with reference to FIG. 1, examples of the learning process and the measurement process performed by the learning device 10 will be described. First, the learning device 10 acquires input information serving as correct answer data from the information processing apparatus 200 (Step S1). As the input information serving as the correct answer data, an arbitrary content, such as thesis, patent publication, weblog, microblog, or news article on the Internet, is applicable.

In this case, the learning device 10 learns an encoder EN that includes a plurality of intermediate layers; a context generator CG that applies, to output of the encoder, an attention matrix indicating a feature of state transition of a node in the intermediate layer; and a decoder DC that outputs output information from output of the context generator (Step S2). For example, in the example illustrated in FIG. 1, the learning device 10 generates the model L10 that includes a model serving as the encoder EN, a model serving as the context generator CG, and a model serving as the decoder DC.

More specifically, the learning device 10 generates the encoder EN that includes an input layer L11 for receiving input of input information, a plurality of intermediate layers L12 for extracting features of the input information based on output from the input layer L11, and an output layer L13 for outputting the features of the input information based on output from the intermediate layer L12. Here, it is assumed that the intermediate layers L12 have a function to extract the features of the input information by gradually reducing the number of dimensions of information output by the input layer L11.

Further, the learning device 10 generates the context generator CG that applies an attention matrix that is based on the state or the connection coefficient of each of the nodes in the intermediate layers L12, to a value that is generated by the encoder EN every time the input information is input, that is, a value that indicates a feature. For example, the learning device 10 generates the context generator CG that generates an attention matrix, in which values based on the states, output, or the connection coefficients of respective nodes included in the intermediate layers L12 at the time of inputting certain input information are adopted as column components and chronological changes of the states of the respective nodes at the time of sequentially inputting pieces of input information are adopted as row components, and that applies the generated attention matrix to the output of the encoder EN.

Furthermore, the learning device 10 generates the decoder DC, which is the decoder DC as the RNN and includes a state layer L20, a reconstruction layer L21, and a reconstruction layer L22. Then, the learning device 10 learns the model L10 such that when pieces of input information included in a sentence are sequentially input to the encoder EN, the context generator CG outputs a feature matrix Ct that is obtained by applying an attention matrix AM to the encoder EN, and the decoder DC sequentially reconstructs pieces of original input information from the feature matrix Ct.

For example, in the example illustrated in FIG. 1, the learning device 10 inputs input information C10 to nodes of the input layer L11. As a result, the encoder EN outputs a feature C of the input information from the output layer L13. Further, the context generator CG generates an attention matrix AM based on the state of each of the nodes included in the intermediate layers L12 with respect to the feature C, and generates the feature matrix Ct by integrating the generated attention matrix AM with the feature C. Then, the context generator CG inputs the generated feature matrix Ct to the decoder DC. In this case, the decoder DC generates output information C20 from the feature matrix Ct.

In this example, the learning device 10 adjusts various parameters of the model L10 such that the input information C10 and the output information C20 become identical to each other or such that the output information C20 has a content corresponding to the input information C10. For example, the learning device 10 adjusts a connection coefficient between the nodes included in the encoder EN and the decoder DC, and adjusts parameters that the context generator CG uses for generating the attention matrix AM from the intermediate layers L12 of the encoder EN. For example, the learning device 10 modifies a parameter (for example, a coefficient or the like) that indicates what value is to be set for a corresponding element in the attention matrix AM and in what state of the nodes the value is to be set.

As a result, the learning device 10 causes the model L10 to learn a feature of the input information C10, and learns the model L10 so as to generate the output information C20 corresponding to the feature of the input information C10. In this example, when generating the output information, the model L10 generates the output information based on the attention matrix AM that is based on the states of the nodes of the intermediate layers L12 included in the encoder EN rather than based on simple values output by the encoder EN. In other words, the model L10 generates the output information based on the attention matrix AM that indicates a topic included in the input information input to the encoder EN, and based on the feature of the input information input to the encoder EN. Therefore, the learning device 10 is able to generate the output information based on not only the feature of the input information but also peripheral information on a feature that is excluded in the encoder EN, so that it is possible to output appropriate output information in accordance with a feature of the input information.

Subsequently, the learning device 10 acquires input information C31 from the information processing apparatus 100 (Step S3). In this case, the learning device 10 performs a measurement process of generating output information C30 by inputting the input information C31 to the learned model L10 (Step S4). Then, the learning device 10 outputs the generated output information C30 to the information processing apparatus 100 (Step S5).

2. Configuration of Learning Device

An example of a functional configuration of the learning device 10 that implements the learning process as described above will be described below. FIG. 3 is a diagram illustrating a configuration example of the learning device according to the embodiment. As illustrated in FIG. 3, the learning device 10 includes a communication unit 20, a storage unit 30, and a control unit 40.

The communication unit 20 is realized by, for example, a network interface card (NIC) or the like. The communication unit 20 is connected to a network N in a wired or wireless manner, and transmits and receives information to and from the information processing apparatuses 100 and 200.

The storage unit 30 is realized by, for example, a semiconductor memory device, such as a random access memory (RAM) or a flash memory, or a storage device, such as a hard disk or an optical disk. Further, the storage unit 30 stores therein a correct answer data database 31 and a model database 32.

In the correct answer data database 31, input information and output information, which are to be used as correct answer data, are registered. For example, FIG. 4 is a diagram illustrating an example of information registered in the correct answer data database according to the embodiment. In the example illustrated in FIG. 4, in the correct answer data database 31, information having items, such as a “correct answer data identifier (ID)”, “input information”, and “output information”, is registered.

In this example, the “correct answer data ID” is information for identifying the input information or the output information to be used as the correct answer data. The “input information” is input information to be used as the correct answer data. The “output information” is output information desired to be output from the decoder DC when the associated “input information” is input to the encoder EN, that is, output information to be used as the correct answer data. It is assumed that, in the correct answer data database 31, various kinds of information related to the correct answer data is registered in addition to the “input information” and the “output information”.

For example, in the example illustrated in FIG. 4, a correct answer data ID of “ID#1”, input information of “input information #1”, and output information of “output information #1” are registered in an associated manner. This information indicates that correct answer data identified by the correct answer data ID of “ID#1” corresponds to the input information of “input information #1” and the output information of “output information #1”. In the example illustrated in FIG. 4, conceptual values such as “input information #1” and “output information #1” are described; however, in reality, various kinds of contents data of input information and output information that is desired to be output upon input of the input information are registered.

Referring back to FIG. 3, the explanation will be continued. In the model database 32, data of the model L10 including the encoder EN and the decoder DC that serve as learning targets are registered. For example, in the model database 32, a connection relationship between nodes in a neural network that is used as the model L10, a function used in each of the nodes, a connection coefficient that is a weight used for sending values between nodes, and the like are registered.

For example, the model L10 is a model that includes an input layer to which information on input information group is input, includes an output layer, includes a first element belonging to any layer that is provided between the input layer and the output layer and that is other than the output layer, and includes a second element for which a value is calculated based on the first element and a weight of the first element, and causes a computer to perform calculation on information input to the input layer on the basis of the first element and the weight of the first element by using each of elements belonging to each of the layers other than the output layer as the first element, generate output information on the basis of the importance that depends on the sequence of appearance and an attribute of each piece of input information, and output the generated output information from the output layer.

The control unit 40 is a controller, and is realized by, for example, causing a processor, such as a central processing unit (CPU) or a micro processing unit (MPU), to execute various programs stored in an internal storage device of the learning device 10 by using a random access memory (RAM) or the like as a work area. Further, the control unit 40 is a controller, and may be realized by, for example, an integrated circuit, such as an application specific integrated circuit (ASIC) or a field programmable gate array (FPGA).

Furthermore, through information processing according to the model L10 stored in the storage unit 30, the control unit 40 operates as the encoder that performs calculation based on a coefficient (in other words, a coefficient corresponding to a feature learned by the model L10) with respect to information on the input information group input to the input layer of the model L10, and that includes an input layer to which input information is input, a plurality of intermediate layers that extract features of the input information from output of the input layer in a stepwise manner, and an output layer that outputs the features of the input information extracted by the plurality of intermediate layers; operates as the context generator that applies, to output of the encoder, an attention matrix including a plurality of column components that are based on a plurality of attributes extracted by the plurality of intermediate layers; and operates as the decoder that generates output information corresponding to input information from the output of the encoder to which the attention matrix has been applied by the context generator.

As illustrated in FIG. 3, the control unit 40 includes an extracting unit 41, a learning unit 42, a receiving unit 43, a generating unit 44, and an output unit 45. The extracting unit 41 and the learning unit 42 perform the learning process as described above, and the receiving unit 43 to the output unit 45 perform the measurement process as described above.

The extracting unit 41 extracts input information. For example, upon receiving input information and output information as correct answer data from the information processing apparatus 200, the extracting unit 41 registers the received input information and the received output information in the correct answer data database 31. Further, at a predetermined timing of performing the learning process, the extracting unit 41 extracts a pair of the input information and the output information registered in the correct answer data database 31, and outputs the extracted pair of the input information and the output information to the learning unit 42.

The learning unit 42 learns an encoder, i.e., the encoder EN, that includes an input layer to which input information is input, a plurality of intermediate layers that extract features of the input information from output of the input layer in a stepwise manner, and an output layer that outputs the features of the input information extracted by the plurality of intermediate layers. Further, the learning unit 42 learns a context generator that applies, to output of the encoder, an attention matrix including a plurality of column components that are based on a plurality of attributes extracted by the plurality of intermediate layers. Furthermore, the learning unit 42 learns a decoder that generates output information corresponding to the input information from the output of the encoder to which the attention matrix has been applied by the context generator.

Here, the learning unit 42 applies an attention matrix including a plurality of column components that are based on states of nodes included in the intermediate layers at the time of inputting information to the input layer. For example, the learning unit 42 learns a context generator that applies an attention matrix in which values corresponding to states of respective nodes included in the same intermediate layer are arranged in the same column.

The learning unit 42 may learn a context generator that applies an attention matrix that is based on a plurality of submatrices corresponding to states of some of the nodes included in the plurality of intermediate layers. Further, the learning unit 42 may learn an encoder that includes a plurality of intermediate layers including nodes that generate newly output information on the basis of newly input information and previously output information, that is, an encoder including intermediate layers having a function of the RNN.

When the encoder includes intermediate layers having a function of the RNN, the learning unit 42 learns a context generator that applies an attention matrix having values of elements corresponding to a chronological structure that is for providing information from the plurality of intermediate layers to other layers. For example, the learning unit 42 learns a context generator that applies an attention matrix, which includes elements corresponding to nodes included in the plurality of intermediate layers and which has column components corresponding to states of respective nodes at the time of inputting predetermined information and row components corresponding to chronological states of the respective nodes. Further, the learning unit 42 learns a context generator that applies an attention matrix, in which a row component corresponding to a node to which information is not provided from other nodes is set to zero in a certain chronological sequence.

The learning unit 42 may learn a context generator that applies an eigenvalue, an eigenvector, or a singular value of the attention matrix to output of the encoder.

For example, the learning unit 42 generates the encoder EN that includes an input layer, a plurality of intermediate layers, and an output layer. Further, the learning unit 42 generates a context generator CG that generates an attention matrix based on states of the plurality of intermediate layers included in the encoder EN, and that applies the generated attention matrix to output of the encoder EN. Furthermore, the learning unit 42 generates the decoder DC that outputs output information corresponding to output of the encoder EN to which the attention matrix has been applied by the context generator CG, that is, the decoder that outputs output information corresponding to the input information from a feature matrix.

Furthermore, upon receiving a pair of input information and output information to be used as correct answer data from the extracting unit 41, the learning unit 42 inputs the received input information to the input layer of the encoder EN and causes the decoder DC to output the received output information. Then, the learning unit 42 learns the decoder DC, the context generator CG, and the encoder EN such that output information output by the decoder DC approaches the output information serving as the correct answer data. For example, the learning unit 42 corrects a connection coefficient of the decoder DC or the encoder EN by a back-propagation method or the like. The learning unit 42 may correct various parameters that are used by the context generator CG for generating an attention matrix from the states of the intermediate layers. Then, the learning unit 42 registers, in the model database 32, the model L10 that includes the encoder EN, the context generator CG, and the decoder DC for which learning has been performed.

When the encoder EN includes intermediate layers having a function of the RNN, output of nodes included in the intermediate layers at a time t is represented by, for example, a logistic function indicated by a function f in Equation (1). The suffix t in Equation (1) represents a chronological order of input information that has last been input among the input information included in the input information group. Further, yₜ₋₁ in Equation (1) indicates previous output of the node of the output layer of the encoder, sₜ₋₁ indicates previous output of the node of the intermediate layer, and Cₜ indicates output of a new input layer.

sₜ=f(yₜ₋₁,sₜ₋₁,Cₜ) (1)

Here, a weighting parameter indicated by αₜⱼ in Equation (2) below is introduced. In this example, h in Equation (2) represents output of the encoder.

αₜⱼ=q(hⱼ,sₜ₋₁), (2)

When a matrix with the weighting parameters as described above is adopted as the attention matrix, a feature matrix output by the context generator is represented by a matrix indicated by Equation (3) below.

Cₜ=Σⱼ₌₁^{T}αₜⱼhⱼ, (3)

The receiving unit 43 receives input information from the information processing apparatus 100. In this case, the receiving unit 43 outputs the received input information to the generating unit 44.

The generating unit 44 generates output information from the input information using the model L10 for which learning has been performed through the learning process as described above. For example, the generating unit 44 inputs the input information to the input layer of the encoder EN included in the model L10. Then, the generating unit 44 generates output information on the basis of information that is output from the output layer of the decoder DC included in the model L10.

The output unit 45 outputs output information corresponding to the input information received from the information processing apparatus 100. For example, the output unit 45 transmits output information generated by the generating unit 44 to the information processing apparatus 100.

3. Example of Flow of Process Performed by Learning Device

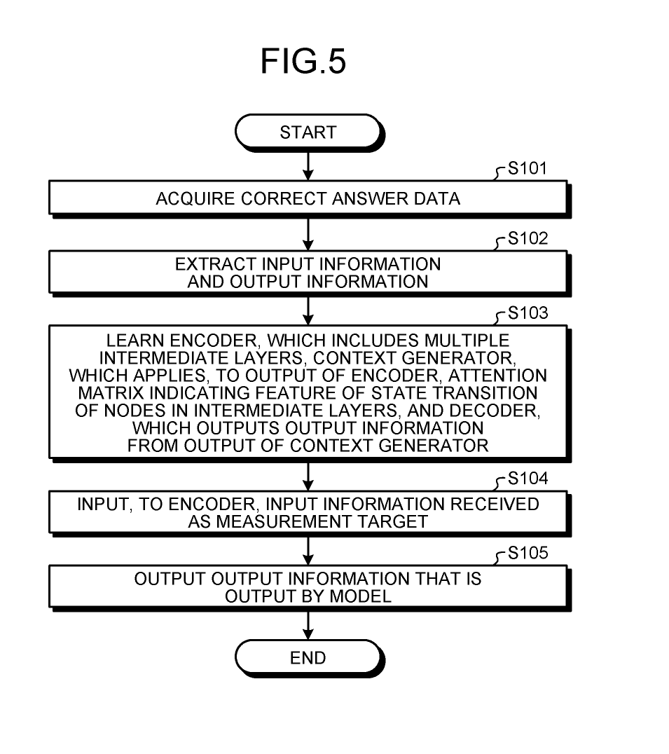

Next, an example of the flow of a process performed by the learning device 10 will be described below with reference to FIG. 5. FIG. 5 is a flowchart for explaining an example of the flow of the process according to the embodiment. First, the learning device 10 acquires the correct answer data (Step S101). Subsequently, the learning device 10 extracts the input information and the output information acquired as the correct answer data (Step S102), and learns an encoder that includes a plurality of intermediate layers, a context generator that applies, to output of the encoder, an attention matrix indicating a feature of state transition of nodes of the intermediate layers, and a decoder that outputs output information from the output of the context generator (Step S103). Further, the learning device 10 inputs input information that has been received as a measurement target to the encoder (Step S104), outputs output information output by the model (Step S105), and ends the process.

4. Modification

The example of the learning process performed by the learning device 10 has been explained above. However, the embodiment is not limited to this example. Variations of the learning process performed by the learning device 10 will be described below.

4-1. DPCN

The learning device 10 may learn the model L10 including the encoder EN or the decoder DC, the entire of which is configured by a single DPCN. Further, the learning device 10 may learn the model L10 including the decoder DC, in which each of the state layer L20, the reconstruction layer L21, and the reconstruction layer L22 is configured by a DPCN.

4-2. Configuration of Apparatus

In the above described example, the learning device 10 performs the learning process and the measurement process inside the learning device 10. However, the embodiment is not limited to this example. For example, it may be possible to cause the learning device 10 to perform only the learning process and cause a different device to perform the measurement process. For example, it may be possible to cause the learning device 10 to use a program parameter including the model L10 having the encoder and the decoder generated through the learning process as described above, and cause an information processing apparatus other than the learning device 10 to perform the measurement process as described above. Further, the learning device 10 may store the correct answer data database 31 in an external storage server.

4-3. Others

Of the processes described in the embodiments, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in the drawings are not limited to those illustrated in the drawings.

In addition, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

Furthermore, the embodiments described above may be arbitrarily combined as long as the processes do not conflict with each other.

5. Program

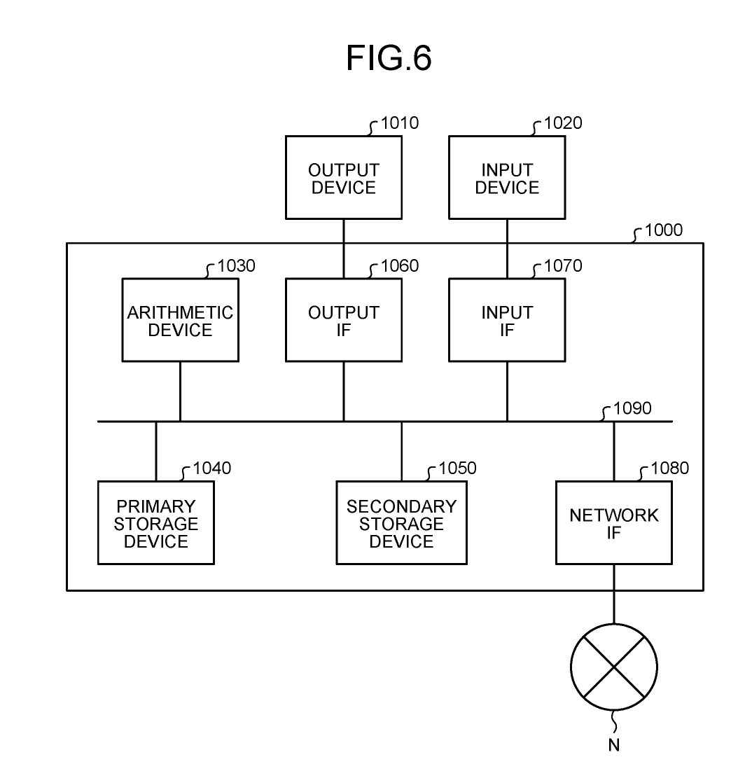

The learning device 10 according to the embodiment described above is realized by, for example, a computer 1000 having a configuration as illustrated in FIG. 6. FIG. 6 is a diagram illustrating an example of a hardware configuration. The computer 1000 is connected to an output device 1010 and an input device 1020, and includes an arithmetic device 1030, a primary storage device 1040, a secondary storage device 1050, an output interface (IF) 1060, an input IF 1070, and a network IF 1080, all of which are connected to one another via a bus 1090.

The arithmetic device 1030 operates based on a program stored in the primary storage device 1040 or the secondary storage device 1050 or a program read from the input device 1020, and executes various processes. The primary storage device 1040 is a memory device, such as a RAM, that primarily stores therein data to be used by the arithmetic device 1030 for various calculations. The secondary storage device 1050 is a storage device for registering various databases and data to be used by the arithmetic device 1030 for various calculations, and is realized by a read only memory (ROM), a hard disk drive (HDD), a flash memory, or the like.

The output IF 1060 is an interface for transmitting information, which is to be an output target, to the output device 1010, such as a monitor or a printer, that outputs various kinds of information, and is realized by, for example, a connector of a certain standard, such as a universal serial bus (USB), a digital visual interface (DVI), or a high definition multimedia interface (HDMI) (registered trademark). The input IF 1070 is an interface for receiving information from any kind of the input device 1020, such as a mouse, a keyboard, and a scanner, and is realized by, for example, a USB or the like.

The input device 1020 may be a device that reads information from, for example, an optical recording medium, such as a compact disc (CD), a digital versatile disk (DVD), or a phase change rewritable disk (PD), a magneto optical recording medium, such as a magneto-optical disk (MO), a tape medium, a magnetic recording medium, a semiconductor memory, or the like. Further, the input device 1020 may be an external recording medium, such as a USB memory.

The network IF 1080 receives data from other devices via the network N, sends the data to the arithmetic device 1030, and transmits data generated by the arithmetic device 1030 to other devices via the network N.

The arithmetic device 1030 controls the output device 1010 and the input device 1020 via the output IF 1060 and the input IF 1070. For example, the arithmetic device 1030 loads a program from the input device 1020 or the secondary storage device 1050 onto the primary storage device 1040, and executes the loaded program.

For example, when the computer 1000 functions as the learning device 10, the arithmetic device 1030 of the computer 1000 executes programs and data (for example, a model) loaded on the primary storage device 1040, to thereby implement the functions of the control unit 40. The arithmetic device 1030 of the computer 1000 reads the programs and data (for example, a model) from the primary storage device 1040 and executes the programs and data. Alternatively, the arithmetic device 1030 may acquire the programs from other devices via the network N.

6. Effect

As described above, the learning device 10 learns: an encoder that includes an input layer to which input information is input, a plurality of intermediate layers that extract features of the input information from output of the input layer in a stepwise manner, and an output layer that outputs the features of the input information extracted by the plurality of intermediate layers; a context generator that applies, to output of the encoder, an attention matrix including a plurality of column components that are based on a plurality of attributes extracted by the plurality of intermediate layers; and a decoder that generates output information corresponding to the input information from the output of the encoder to which the attention matrix has been applied by the context generator.

Further, the learning device 10 learns a context generator that applies an attention matrix that has a plurality of column components based on states of respective nodes included in the intermediate layers at the time of inputting information to the input layer. Furthermore, the learning device 10 learns a context generator that applies an attention matrix in which values corresponding to states of respective nodes included in the same intermediate layer are arranged in the same column.

Moreover, the learning device 10 learns a context generator that applies an attention matrix that is based on a plurality of submatrices corresponding to states of some of the nodes included in the plurality of intermediate layers. Furthermore, the learning device 10 learns an encoder that includes a plurality of intermediate layers including nodes that generate newly output information on the basis of newly input information and previously output information.

Moreover, the learning device 10 learns a context generator that applies an attention matrix having values of elements corresponding to a chronological structure that is for providing information from the intermediate layers included in the encoder to other layers. Furthermore, the learning device 10 learns a context generator that applies an attention matrix, which includes elements corresponding to nodes included in the plurality of intermediate layers and which has column components corresponding to states of the respective nodes at the time of inputting predetermined information to the input layer and row components corresponding to chronological states of the respective nodes. For example, the learning device 10 learns a context generator that applies an attention matrix in which a row component corresponding to a node to which information is not provided from other nodes is set to zero in a certain chronological sequence.

Moreover, the learning device 10 learns a context generator that applies an eigenvalue, an eigenvector, or a singular value of the attention matrix to output of the encoder

As a result of the process as described above, the learning device 10 is able to learn the model L10 that generates output information from the input information by taking into account information that is lost at the time of encoding (that is, peripheral information on a feature), so that it is possible to output appropriate output information in accordance with features of the input information.

While the embodiments of the present application have been explained in detail above based on the drawings, the embodiments are described by way of example, and the present invention may be embodied in various other forms with various changes or modifications based on knowledge of person skilled in the art, in addition to the embodiments described in this specification.

Furthermore, “a unit” recited in this document may be replaced with “a section, a module, or a means” or “a circuit”. For example, the generating unit may be replaced with a generating means or a generating circuit.

According one aspect of the embodiment, it is possible to output appropriate output information in accordance with a feature of the input information.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A learning device comprising:
a learning unit that learns
an encoder that includes an input layer to which input information is input, a plurality of intermediate layers that extract features of the input information from output of the input layer in a stepwise manner, and an output layer that outputs the features of the input information extracted by the plurality of intermediate layers;
an applier that applies, to output of the encoder, an attention matrix including a plurality of column components that are based on a plurality of attributes extracted by the plurality of intermediate layers; and
a decoder that generates output information corresponding to the input information from the output of the encoder to which the attention matrix has been applied by the applier.

2. The learning device according to claim 1, wherein the learning unit learns the applier that applies an attention matrix including a plurality of column components that are based on states of nodes included in the intermediate layers at the time of inputting information to the input layer.

3. The learning device according to claim 2, wherein the learning unit learns the applier that applies an attention matrix in which values corresponding to states of nodes included in a same intermediate layer are arranged in a same column.

4. The learning device according to claim 3, wherein the learning unit learns the applier that applies an attention matrix that is based on a plurality of submatrices corresponding to states of some of the nodes included in the plurality of intermediate layers.

5. The learning device according to claim 1, wherein the learning unit learns the encoder that includes a plurality of intermediate layers including a node that generate newly output information on the basis of newly input information and previously output information.

6. The learning device according to claim 5, wherein the learning unit learns the applier that applies an attention matrix having values of elements corresponding to a chronological structure that is for providing information from the plurality of intermediate layers included in the encoder to other layers.

7. The learning device according to claim 5, wherein the learning unit learns the applier that applies an attention matrix, which includes elements corresponding to nodes included in the plurality of intermediate layers and which includes column components corresponding to states of the respective nodes at the time of inputting predetermined information to the input layer and row components corresponding to chronological states of the respective nodes.

8. The learning device according to claim 7, wherein the learning unit learns the applier that applies an attention matrix in which a row component corresponding to a node to which information is not provided from other nodes is set to zero in a certain chronological sequence.

9. The learning device according to claim 1, wherein the learning unit learns a applier that applies one of an eigenvalue, an eigenvector, and a singular value of the attention matrix to output of the encoder.

10. A non-transitory computer-readable storage medium having stored therein a program parameter that includes a recurrent neural network including an encoder, a applier, and a decoder that are generated by a learning method comprising:
learning
the encoder that includes an input layer to which input information is input, a plurality of intermediate layers that extract features of the input information from output of the input layer in a stepwise manner, and an output layer that outputs the features of the input information extracted by the plurality of intermediate layers;
the applier that applies, to output of the encoder, an attention matrix including a plurality of column components that are based on a plurality of attributes extracted by the plurality of intermediate layers; and
the decoder that generates output information corresponding to the input information from the output of the encoder to which the attention matrix has been applied by the applier.

11. A learning method implemented by a learning device, the learning method comprising:
learning
an encoder that includes an input layer to which input information is input, a plurality of intermediate layers that extract features of the input information from output of the input layer in a stepwise manner, and an output layer that outputs the features of the input information extracted by the plurality of intermediate layers;
an applier that applies, to output of the encoder, an attention matrix including a plurality of column components that are based on a plurality of attributes extracted by the plurality of intermediate layers; and
a decoder that generates output information corresponding to the input information from the output of the encoder to which the attention matrix has been applied by the applier.
